(19) United States
(12) Patent Application Publication
(10) Pub. No.: US 2008/0302092 A1
(43) Pub. Date: Dec. 11, 2008

(54) NOX ADSORBER CATALYST AND SYSTEM THEREFOR

(76) Inventors: Aleksey Yezerets, Columbus, IN (US); Neal W. Currier, Columbus, IN (US); Lyle E Kocher, Franklin, IN (US); Michael J Ruth, Franklin, IN (US)

Correspondence Address: CUMMINS, INC., 11 SOUTH MERIDIAN, INDIANAPOLIS, IN, 46204, US

(21) Appl. No.: 11/758,428

(22) Filed: Jun. 5, 2007

Related U.S. Application Data
(63) Continuation of application No. 11/613,748, filed on Dec. 20, 2006.

(51) Int. Cl. F01N 3/10; G06F 19/00

(52) U.S. Cl. 60/299; 60/274; 60/276; 60/287; 701/109

(57) ABSTRACT

A NOx adsorber catalyst may comprise a housing defining an inlet configured to receive exhaust gas produced by an internal combustion engine, an outlet and a chamber between the inlet and the outlet. A NOx adsorber element may be positioned in the chamber adjacent to the inlet. The NOx adsorber element may be configured to trap NOx in the exhaust gas during lean fuel operation of the engine, and to release the trapped NOx and reduce the released NOx to nitrogen during rich fuel operation of the engine. A hydrocarbon trap may be positioned in the chamber between the NOx adsorber element and the outlet. The hydrocarbon trap may be configured to trap hydrocarbons that travel through the NOx adsorber element during the rich fuel operation of the engine. The trapped hydrocarbons may be oxidized by oxygen present in the exhaust gas during lean fuel operation following rich fuel operation.

### FIELD OF THE INVENTION

The present invention relates generally to exhaust gas aftertreatment components, and more specifically to the systems and devices for processing NOx present in exhaust gas produced by an internal combustion engine.

### BACKGROUND

NOx adsorber catalysts for processing NOx present in exhaust gas produced by internal combustion engines are generally known. It is desirable to minimize, or at least reduce, the passage of hydrocarbons through such exhaust gas aftertreatment devices during rich fuel conditions typically associated with device regeneration events.

### SUMMARY

The present invention may comprise one or more of the features recited in the attached claims, and/or one or more of the following features and combinations thereof. A NOx adsorber catalyst may comprise a housing defining an inlet at one end configured to receive exhaust gas produced by an internal combustion engine, an outlet at an opposite end and a chamber between the inlet and the outlet. A NOx adsorber element may be positioned in the chamber adjacent to the inlet of the housing. The NOx adsorber element may be configured to trap NOx in the exhaust gas during lean fuel operation of the engine, and to release the trapped NOx and reduce the released NOx to nitrogen during rich fuel operation of the engine. A hydrocarbon trap may be positioned in the chamber between the NOx adsorber element and the outlet of the housing. The hydrocarbon trap may be configured to trap hydrocarbons that travel through the NOx adsorber element during the rich fuel operation of the engine. The trapped hydrocarbons are oxidized by oxygen present in the exhaust gas during lean fuel operation of the engine following rich fuel operation.

The hydrocarbon trap may be integral with the NOx adsorber element. Alternatively, the hydrocarbon trap may be attached to the NOx adsorber element. Alternatively still, the hydrocarbon trap may be spaced apart from the NOx adsorber element within the chamber of the housing.

The hydrocarbon trap may comprise a substrate wash-coated with zeolite-containing material.

A NOx adsorber catalyst may comprise a housing defining an inlet at one end configured to receive exhaust gas produced by an internal combustion engine, an outlet at an opposite end and a chamber between the inlet and the outlet. A NOx adsorber element may be positioned in the chamber. The NOx adsorber element may include a first portion adjacent to the inlet of the housing and a second portion integral with the first portion with the first portion positioned between the inlet of the housing and the second portion. The first portion of the NOx adsorber element may be configured to trap NOx in the exhaust gas during lean fuel operation of the engine, and to release the trapped NOx and reduce the released NOx to nitrogen during rich fuel operation of the engine. The second portion of the NOx adsorber element may be configured to trap hydrocarbons that travel through the first portion during the rich fuel operation of the engine. The trapped hydrocarbons may be oxidized by oxygen present in the exhaust gas during lean fuel operation of the engine following rich fuel operation.

A NOx adsorber catalyst may comprise a housing defining an inlet at one end configured to receive exhaust gas produced by an internal combustion engine, an outlet at an opposite end and a chamber between the inlet and the outlet. A NOx adsorber element may be positioned in the chamber adjacent to the inlet of the housing. The NOx adsorber element may be configured to trap NOx in the exhaust gas during lean fuel operation of the engine, and to release the trapped NOx and reduce the released NOx to nitrogen during rich fuel operation of the engine. A hydrocarbon trap, separate from the NOx adsorber element, may be positioned in the chamber between the NOx adsorber element and the outlet of the housing. The hydrocarbon trap may be configured to trap hydrocarbons that travel through the NOx adsorber element during the rich fuel operation of the engine. The trapped hydrocarbons may be oxidized by oxygen present in the exhaust gas during lean fuel operation of the engine following rich fuel operation. The hydrocarbon trap may be attached to the NOx adsorber element. Alternatively, the hydrocarbon trap may be spaced apart from the NOx adsorber element within the chamber of the housing.

A system for processing NOx present in exhaust gas produced by an internal combustion engine may comprise a NOx adsorber catalyst having housing defining an inlet at one end that is configured to receive the exhaust gas, an outlet at an opposite end and a chamber between the inlet and the outlet. A NOx adsorber element may be positioned in the chamber adjacent to the inlet of the housing. The NOx adsorber element may be configured to trap NOx in the exhaust gas during lean fuel operation of the engine, and to release the trapped NOx and reduce the released NOx to nitrogen during rich fuel operation of the engine. A hydrocarbon trap may be positioned in the chamber between the NOx adsorber element and the outlet of the housing. The hydrocarbon trap may be configured to trap hydrocarbons that travel through the NOx adsorber element during the rich fuel operation of the engine. A fuel system may be configured to supply fuel to the engine. A control circuit may include a memory having stored therein a set of instructions that are executable by the control circuit to control the fuel system to normally supply fuel for lean fuel operation of the engine, and to control the fuel system to supply fuel for alternate rich fuel operation of the engine and lean fuel operation of the engine to regenerate the NOx adsorber. The hydrocarbons trapped in the hydrocarbon trap may be oxidized by oxygen present in the exhaust gas during lean fuel operation of the engine following rich fuel operation.

The system may further comprise an oxidation catalyst positioned between the engine and the NOx adsorber. The instructions stored in the memory may include instructions that are executable by the control circuit to control the fuel system to introduce hydrocarbons in the form of unburned or partially burned fuel into the exhaust gas during regeneration of the NOx adsorber. The oxidation catalyst may react with the introduced hydrocarbons to heat the exhaust gas supplied to the NOx adsorber to an elevated temperature suitable for regeneration of the NOx adsorber.

The hydrocarbon trap may be integral with the NOx adsorber element. Alternatively, the hydrocarbon trap may be attached to the NOx adsorber element. Alternatively still, the hydrocarbon trap may be spaced apart from the NOx adsorber element within the chamber of the housing.

The hydrocarbon trap may comprise a substrate wash-coated with zeolite-containing material.

The system may further comprise an oxygen sensor configured to produce an oxygen signal corresponding to an oxygen concentration of exhaust gas exiting the NOx adsorber catalyst. The instructions stored in the memory include instructions that are executable by the control circuit to control the fuel system to supply fuel for alternate rich fuel operation of the engine and lean fuel operation of the engine to regenerate the NOx adsorber according to a closed-loop control strategy as a function of the oxygen concentration of exhaust gas exiting the NOx adsorber catalyst.

The system may further comprise means for determining an oxygen concentration of exhaust gas entering the NOx adsorber catalyst. The instructions stored in the memory include instructions that are executable by the control circuit to control the fuel system to supply fuel for alternate rich fuel operation of the engine and lean fuel operation of the engine to regenerate the NOx adsorber according to the closed-loop control strategy further as a function of the oxygen concentration of exhaust gas entering the NOx adsorber catalyst.

### BRIEF DESCRIPTION OF THE DRAWINGS

FIG. 1 is a bock diagram of a closed-loop control system for controlling operation of a NOx adsorber catalyst in an exhaust gas aftertreatment system for an internal combustion engine.

FIG. 2 is a cross section of one embodiment of the NOx adsorber catalyst of FIG. 1.

FIG. 3 is a cross section of another embodiment of the NOx adsorber catalyst of FIG. 1.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

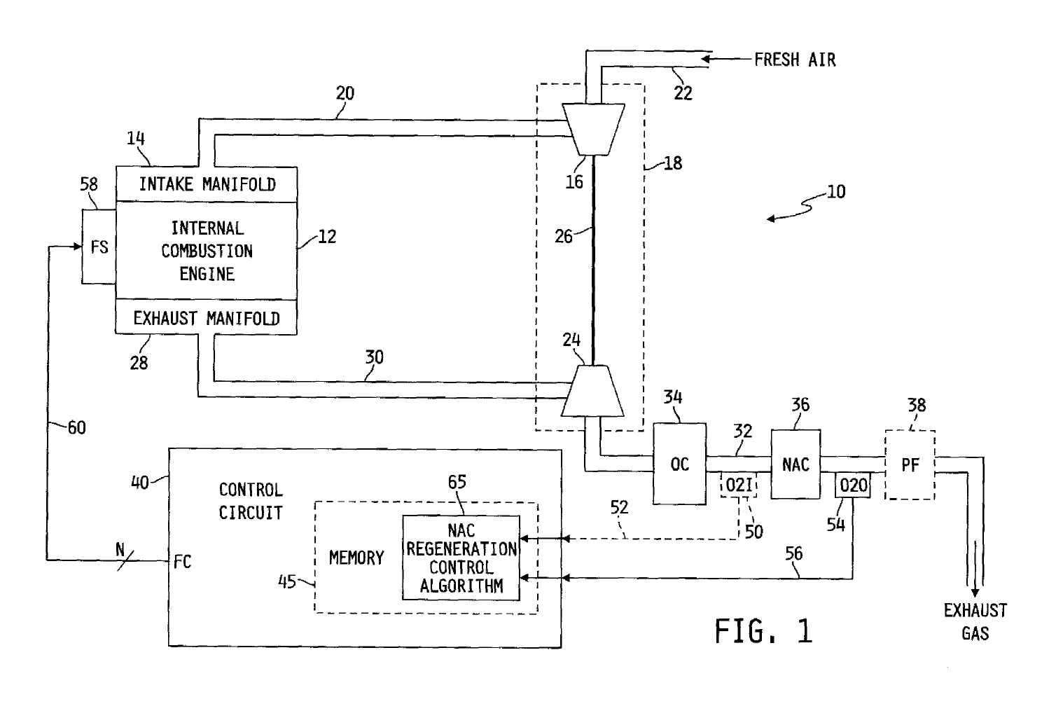

Referring now to FIG. 1, one illustrative embodiment of a closed-loop control system 10 is shown for controlling regeneration of a NOx adsorber catalyst 36 in an exhaust gas aftertreatment system for an internal combustion engine 12. In the illustrated embodiment, the system 10 includes an internal combustion engine 12 having an intake manifold 14 fluidly coupled to a fresh air outlet of a compressor 16 of a turbocharger 18 via a conduit 20. A fresh air inlet of the compressor 16 is fluidly coupled to a fresh air intake conduit 22. A turbine 24 of the turbocharger 18 is mechanically coupled via a rotational drive shaft 26 to the compressor 16 in a conventional manner. An exhaust gas inlet of the turbine 24 is fluidly coupled to an exhaust manifold 28 of the engine 12 via an exhaust gas conduit 30. An exhaust gas outlet of the turbine 24 is fluidly coupled to an exhaust gas conduit 32.

In the illustrated embodiment, an exhaust gas aftertreatment system 34 includes a conventional oxidation catalyst (OC) 34 that is disposed in-line with the exhaust gas conduit 32. The oxidation catalyst 36 includes a conventional catalyst element responsive to hydrocarbons introduced into the exhaust gas stream to elevate the temperature of the exhaust gas to a temperature suitable for regeneration of one or more downstream exhaust gas aftertreatment components. One such downstream exhaust gas component illustrated in FIG. 1 comprises a NOx adsorber catalyst (NAC) 36. The exhaust gas aftertreatment may further, but need no, include a conventional particulate filter 38 as shown in phantom in FIG. 1. It will be understood that the exhaust gas aftertreatment system illustrated in FIG. 1 may include additional exhaust gas aftertreatment components. It will also be understood that the system 10 may, but need not, include the turbocharger 18, and turbocharger 18 is accordingly illustrated in FIG. 1 as being surrounded by a dashed-line block.

The system 10 further includes a control circuit 40 configured to control the overall operation of the engine 12. In one embodiment, the control circuit 40 is a microprocessor-based control circuit typically referred to as an electronic or engine control module (ECM), or electronic or engine control unit (ECU). It will be understood, however, that the control circuit 40 may generally be or include one or more general purpose or application specific control circuits arranged and operable as will be described hereinafter. The control circuit 40 includes, or is coupled to, a memory unit 45 that stores therein a number of software algorithms executable by the control circuit 40 to control various operations of the engine 12.

The control circuit 40 includes a number of inputs configured to receive sensory data corresponding to one or more operating parameters of the exhaust gas aftertreatment system, and a number of outputs configured to control one or more actuators. For example, the exhaust gas aftertreatment system includes a conventional oxygen sensor (also known as a lambda sensor) 54 that is disposed in fluid communication with the exhaust gas conduit 32 between the NAC 36 and the particulate filter 38, if included in the aftertreatment system, and otherwise between the exhaust gas outlet of the NAC 36 and ambient. The oxygen sensor 54 is electrically connected to an input of the control circuit 40 via a signal path 56, and is configured to produce a signal on the signal path 56 corresponding to the oxygen concentration of the exhaust gas exiting the NAC 36. The exhaust gas aftertreatment system may further include another oxygen sensor 50 that is disposed in fluid communication with the exhaust gas conduit 32 between the OC 34 and the NAC 36 as shown in phantom in FIG. 1. If included in the exhaust gas aftertreatment system, the oxygen sensor 50 is electrically connected to another input of the control circuit 40, and is configured to produce a signal on the signal path 52 corresponding to the oxygen concentration of the exhaust gas entering the NAC 36. In alternative embodiments, the memory unit 45 may include one or more conventional software algorithms executable by the control circuit 40 to estimate the oxygen concentration of the exhaust gas entering the NAC 36, and in such embodiments the oxygen sensor 50 may be omitted.

A conventional fuel system 58 is coupled to the engine 12, and is electrically connected to the control circuit 42 via a number, N, of signal paths 60, wherein N may be any positive integer. The control circuit 40 includes conventional fueling logic which is responsive to a number of engine operating conditions to determine appropriate fueling commands in a conventional manner. The control circuit 40 provides the fueling commands (FC) to the fuel system 58 via the one or more signal paths 60 to thereby control the fuel system 58 in a conventional manner to supply fuel to the engine 12.

It will be understood that the system 10 may include other conventional components, and in particular the engine 12 may have one or more air handling components and/or sub-systems coupled thereto as is known in the art. Examples of such one or more air handling components and/or sub-systems may include, but should not be limited to, a conventional turbocharger, one or any combination of a conventional electronically controllable exhaust gas recirculation (EGR) system, a conventional electronically controllable intake air throttle, a conventional electronically controllable exhaust gas throttle, an electronically controllable variable geometry turbocharger, a conventional electronically controllable wastegate configured to selectively route exhaust gas around a turbocharger turbine, and the like.

The memory unit 45 of the control circuit 40 includes a number of conventional software algorithms to control operation of the fuel system 58 under different operating conditions. For purposes of this disclosure, lean fuel operation of the engine 12 is defined as an air-to-fuel ratio of the air-fuel mixture supplied to the engine 12 that is greater than the stoichiometric ratio for the particular fuel being used. Rich fuel operation of the engine 12, in contrast, is defined as an air-to-fuel ratio of the air-fuel mixture supplied to the engine 12 that is less than the stoichiometric ratio for the particulate fuel being used. It is generally understood in the industry that lean and rich fuel operation of the engine 12 is typically referred to in terms of a parameter called “lambda” or “λ.” Lambda is defined as the air-to-fuel ratio of the air-fuel mixture that is normalized to unity at the stoichiometric ratio for the fuel being used. Thus, lambda values greater than unity generally correspond to lean fuel operation of the engine 12, and lambda values less than unity generally correspond to rich fuel operation of the engine 12.

During normal operation of the engine 12, the control circuit 40 is operable, under the direction of one conventional software algorithm, to control the fuel system 58 to supply fuel for lean fuel operation of the engine 12. The NOx adsorber catalyst may typically require periodic regeneration to release and oxidize trapped NOx. During such NOx adsorber regeneration, the control circuit 40 is operable, under the direction of a conventional NAC regeneration control algorithm 65 to control the fuel system 58 to supply fuel for alternate rich fuel operation of the engine 12 and lean fuel operation of the engine 12, and to also control the fuel system 58 in a conventional manner to introduce hydrocarbons in the form of unburned or partially burned fuel into the exhaust gas produced by the engine. The oxidation catalyst 34 is configured to react with the hydrocarbons according to a known exothermic reaction to elevate the temperature of the exhaust gas supplied to the NOx adsorber catalyst 36 to a temperature range suitable for regeneration of the NOx adsorber 36. The control circuit 40 executes the software algorithm 65 to initiate and control regeneration of the NOx adsorber catalyst 36 in a conventional manner. For example, the software algorithm 65 may define a conventional closed-loop control strategy for controlling the fuel system 58 to selectively supply hydrocarbons to the exhaust gas in the form of unburned or partially burned fuel and to supply fuel in a periodic lean-to-rich and rich-to-lean fueling strategy as a function of the oxygen concentration of the exhaust gas exiting the NOx adsorber catalyst 36. Alternatively or additionally, the software algorithm 65 may define a conventional closed-loop control strategy for controlling the fuel system 58 to selectively supply hydrocarbons to the exhaust gas in the form of unburned or partially burned fuel and to supply fuel in a periodic lean-to-rich and rich-to-lean fueling strategy as a function of the oxygen concentrations of the exhaust gas entering and exiting the NOx adsorber catalyst 36. Alternatively, the software algorithm 65 may define an open-loop control strategy for controlling the fuel system 58 in a conventional open-loop manner to selectively supply hydrocarbons to the exhaust gas in the form of unburned or partially burned fuel and to supply fuel in a periodic lean-to-rich and rich-to-lean fueling strategy.

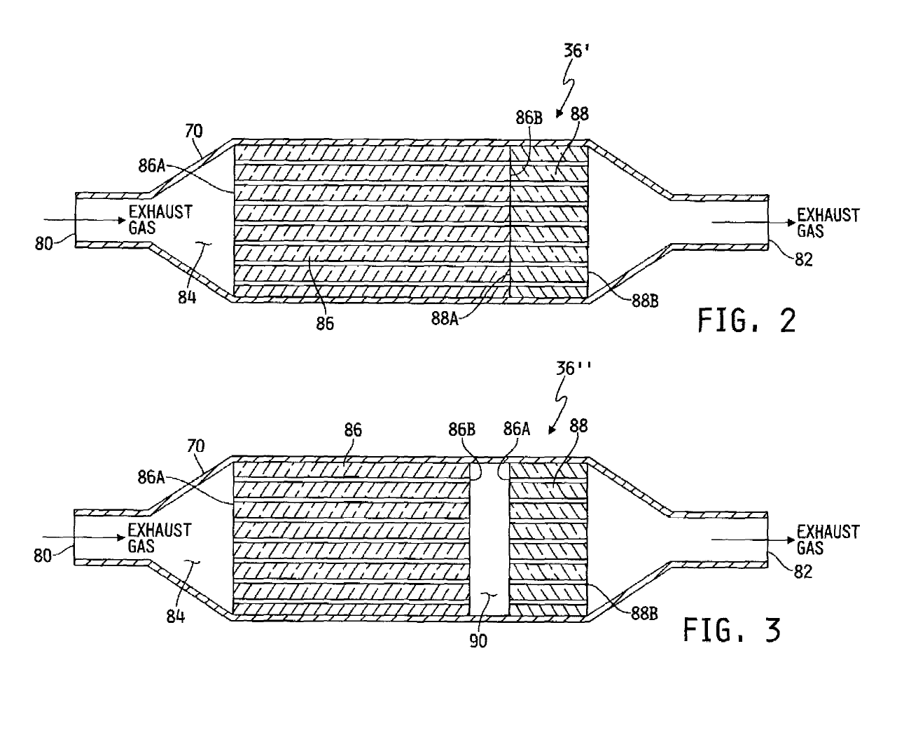

Referring now to FIG. 2, one illustrative embodiment 36′ of the NOx adsorber catalyst 36 is shown. The NOx adsorber catalyst 36′ includes a housing 70 having an exhaust gas inlet 80 configured to receive exhaust gas supplied by the engine 12, and exhaust gas outlet 82 and a chamber 84 defined between the exhaust gas inlet 80 and outlet 82. A conventional NOx adsorber element 86 is positioned in the chamber 84 with a front face 86A facing the exhaust gas inlet 80 of the housing 70 and a rear face 86B facing the exhaust gas outlet 82 of the housing 70. The NOx adsorber element 86 may be of conventional construction and is configured to trap NOx therein during normal, lean fuel operation of the engine 12, and to release the trapped NOx and reduce the released NOx to nitrogen during rich fuel operation of the engine 12, i.e., during regeneration of the NOx adsorber catalyst as described hereinabove.

A hydrocarbon trap 88 is also positioned within the chamber 84 of the housing 70 with a front face 88A facing the rear face 86B of the NOx adsorber element 86 and a rear face 88B facing the exhaust gas outlet 82 of the housing 70. The hydrocarbon trap 88 may comprise a conventional substrate that is wash-coated with a suitable hydrocarbon trapping coating such as a zeolite-containing material or other suitable coating(s). The hydrocarbon trap 88 is configured to trap hydrocarbons that travel through, or slip past, the NOx adsorber element during the rich fuel operation of the engine 12 so that the exhaust gas exiting the NOx adsorber catalyst 36′ has little or no hydrocarbon content during rich fuel operation of the engine 12. The trapped hydrocarbons are then oxidized by oxygen present in the exhaust gas during lean fuel operation of the engine 12 that follows rich fuel operation of the engine 12. While the hydrocarbon trap 88 traps hydrocarbons during rich fuel operation of the engine 12 as just described, it allows pass through of CO and H₂. As such, inclusion of the hydrocarbon trap 88 should not adversely affect detection of a lean-to-rich lambda transition by the downstream oxygen sensor 54 in the system 10. Moreover, since the hydrocarbon trap 88 should trap most or all of the hydrocarbons that slip through the NOx adsorber element 86 during rich fuel operation, the downstream oxygen sensor 54 is less likely than NOx adsorber catalysts that do not have the hydrocarbon trap 88 to prematurely detect a rich-to-lean lambda transition, thereby reducing the likelihood of premature ending of the regeneration event.

In the embodiment illustrated in FIG. 2, the rear face 86B of the NOx adsorber element 86 is in contact with the front face 88A of the hydrocarbon trap 88. In one embodiment, the hydrocarbon trap 88 may be attached to the NOx adsorber element 86 or vice versa. In an alternate embodiment, the NOx adsorber element 86 and the hydrocarbon trap 88 may be of unitary construction. In still another embodiment 36″ of the NOx adsorber catalyst 36, as illustrated by example in FIG. 3, the rear face 86B of the NOx adsorber element 86 may be separated from the front face 88A of the hydrocarbon trap 88 by a gap 90. The width of the gap 90 may vary to suit the application, although it will be understood that notwithstanding the width of the gap 90 the NOx adsorber element 86 and the hydrocarbon trap 88 both reside in the chamber 84 defined within the housing 70, and the gap 90 is generally not configured to modify the flow of exhaust gas through the chamber 84.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A NOx adsorber catalyst comprising:
a housing defining an inlet at one end configured to receive exhaust gas produced by an internal combustion engine, an outlet at an opposite end and a chamber between the inlet and the outlet,
a NOx adsorber element positioned in the chamber adjacent to the inlet of the housing, the NOx adsorber element configured to trap NOx in the exhaust gas during lean fuel operation of the engine, and to release the trapped NOx and reduce the released NOx to nitrogen during rich fuel operation of the engine, and
a hydrocarbon trap positioned in the chamber between the NOx adsorber element and the outlet of the housing, the hydrocarbon trap configured to trap hydrocarbons that travel through the NOx adsorber element during the rich fuel operation of the engine,
wherein the trapped hydrocarbons are oxidized by oxygen present in the exhaust gas during lean fuel operation of the engine following rich fuel operation.

2. The NOx adsorber catalyst of claim 1 wherein the hydrocarbon trap is integral with the NOx adsorber element.

3. The NOx adsorber catalyst of claim 1 wherein the hydrocarbon trap is attached to the NOx adsorber element.

4. The NOx adsorber catalyst of claim 1 wherein the hydrocarbon trap is spaced apart from the NOx adsorber element within the chamber of the housing.

5. The NOx adsorber catalyst of claim 1 wherein the hydrocarbon trap comprises a substrate wash-coated with a zeolite-containing material.

6. A NOx adsorber catalyst comprising:
a housing defining an inlet at one end configured to receive exhaust gas produced by an internal combustion engine, an outlet at an opposite end and a chamber between the inlet and the outlet,
a NOx adsorber element positioned in the chamber, the NOx adsorber element including a first portion adjacent to the inlet of the housing and configured to trap NOx in the exhaust gas during lean fuel operation of the engine, and to release the trapped NOx and reduce the released NOx to nitrogen during rich fuel operation of the engine, and a second portion integral with the first portion with the first portion positioned between the inlet of the housing and the second portion, the second portion configured to trap hydrocarbons that travel through the first portion during the rich fuel operation of the engine,
wherein the trapped hydrocarbons are oxidized by oxygen present in the exhaust gas during lean fuel operation of the engine following rich fuel operation.

7. A NOx adsorber catalyst comprising:
a housing defining an inlet at one end configured to receive exhaust gas produced by an internal combustion engine, an outlet at an opposite end and a chamber between the inlet and the outlet,
a NOx adsorber element positioned in the chamber adjacent to the inlet of the housing, the NOx adsorber element configured to trap NOx in the exhaust gas during lean fuel operation of the engine, and to release the trapped NOx and reduce the released NOx to nitrogen during rich fuel operation of the engine, and
a hydrocarbon trap separate from the NOx adsorber element and positioned in the chamber between the NOx adsorber element and the outlet of the housing, the hydrocarbon trap configured to trap hydrocarbons that travel through the NOx adsorber element during the rich fuel operation of the engine,
wherein the trapped hydrocarbons are oxidized by oxygen present in the exhaust gas during lean fuel operation of the engine following rich fuel operation.

8. The NOx adsorber catalyst of claim 7 wherein the hydrocarbon trap is attached to the NOx adsorber element.

9. The NOx adsorber catalyst of claim 7 wherein the hydrocarbon trap is spaced apart from the NOx adsorber element within the chamber of the housing.

10. A system for processing NOx present in exhaust gas produced by an internal combustion engine, comprising:
a NOx adsorber catalyst having housing defining an inlet at one end that is configured to receive the exhaust gas, an outlet at an opposite end and a chamber between the inlet and the outlet, a NOx adsorber element positioned in the chamber adjacent to the inlet of the housing, the NOx adsorber element configured to trap NOx in the exhaust gas during lean fuel operation of the engine, and to release the trapped NOx and reduce the released NOx to nitrogen during rich fuel operation of the engine, and a hydrocarbon trap positioned in the chamber between the NOx adsorber element and the outlet of the housing, the hydrocarbon trap configured to trap hydrocarbons that travel through the NOx adsorber element during the rich fuel operation of the engine,
a fuel system configured to supply fuel to the engine, and
a control circuit including a memory having stored therein a set of instructions that are executable by the control circuit to control the fuel system to normally supply fuel for lean fuel operation of the engine, and to control the fuel system to supply fuel for alternate rich fuel operation of the engine and lean fuel operation of the engine to regenerate the NOx adsorber,
wherein the hydrocarbons trapped in the hydrocarbon trap are oxidized by oxygen present in the exhaust gas during lean fuel operation of the engine following rich fuel operation.

11. The system of claim 10 further comprising an oxidation catalyst positioned between the engine and the NOx adsorber,
wherein the instructions stored in the memory include instructions that are executable by the control circuit to control the fuel system to introduce hydrocarbons in the form of unburned or partially burned fuel into the exhaust gas during regeneration of the NOx adsorber, the oxidation catalyst reacting with the introduced hydrocarbons to heat the exhaust gas supplied to the NOx adsorber to an elevated temperature suitable for regeneration of the NOx adsorber.

12. The system of claim 10 wherein the hydrocarbon trap is integral with the NOx adsorber element.

13. The system of claim 10 wherein the hydrocarbon trap is attached to the NOx adsorber element.

14. The system of claim 1 wherein the hydrocarbon trap is spaced apart from the NOx adsorber element within the chamber of the housing.

15. The system of claim 10 wherein the hydrocarbon trap comprises a substrate wash-coated with a zeolite-containing material.

16. The system of claim 10 further comprising an oxygen sensor configured to produce an oxygen signal corresponding to an oxygen concentration of exhaust gas exiting the NOx adsorber catalyst,
wherein the instructions stored in the memory include instructions that are executable by the control circuit to control the fuel system to supply fuel for alternate rich fuel operation of the engine and lean fuel operation of the engine to regenerate the NOx adsorber according to a closed-loop control strategy as a function of the oxygen concentration of exhaust gas exiting the NOx adsorber catalyst.

17. The system of claim 16 further comprising means for determining an oxygen concentration of exhaust gas entering the NOx adsorber catalyst,
wherein the instructions stored in the memory include instructions that are executable by the control circuit to control the fuel system to supply fuel for alternate rich fuel operation of the engine and lean fuel operation of the engine to regenerate the NOx adsorber according to the closed-loop control strategy further as a function of the oxygen concentration of exhaust gas entering the NOx adsorber catalyst.
